(19) United States
(12) Patent Application Publication
(10) Pub. No.: US 2005/0084605 A1
(43) Pub. Date: Apr. 21, 2005

(54) Method for forming electroluminescent devices

(76) Inventor: Poopathy Kathirgamanathan, North Harrow (GB)

Correspondence Address: Andover-IP-Law, 44 Park Street, Suite 300, Andover, MA, 01810, US

(21) Appl. No.: 10/503,835

(22) PCT Filed: Feb. 6, 2003
(86) PCT No.: PCT/GB03/00542

(30) Foreign Application Priority Data
Feb. 8, 2002 (GB) 0202997.3

(51) Int. Cl. B05D 5/06

(52) U.S. Cl. 427/64

(57) ABSTRACT

A method for forming an electroluminescent device deposits the electroluminescent material by ink jet printing.

### The present invention relates to a method of forming electroluminescent devices.

Materials which emit light when an electric current is passed through them are well known and used in a wide range of display applications. Liquid crystal devices and devices which are based on inorganic semiconductor systems are widely used, however these suffer from the disadvantages of high energy consumption, high cost of manufacture, low quantum efficiency and the inability to make flat panel displays.

Organic polymers have been proposed as useful in electroluminescent devices, but it is not possible to obtain pure colours, they are expensive to make and have a relatively low efficiency.

Another compound which has been proposed is aluminium quinolate, but this requires dopants to be used to obtain a range of colours and has a relatively low efficiency.

Patent application Nos. WO98/58037, WO98/58037, WO 0026323, WO 0032719, WO 00/32717, WO 00/032718, WO 00/44851, WO 00/43444, WO 00/43446, WO 00/43447, WO 02/075820 and PCT/GB02/01837, PCT/GB02/01884, PCT/GB02/02094, PCT/GB02,02092, PCT/GB02,02093, PCTGB02/02722, PCT/GB02/003163, PCT/GB02/003588, PCT/GB02/004761 describes a range of complexes and structures including those using lanthanides, actinides and other rare earth chelates which can be used in electroluminescent devices which have improved properties and give better results.

U.S. Pat. No. 5,128,587 discloses an electroluminescent device which consists of an organometallic complex of rare earth elements of the lanthanide series sandwiched between a transparent electrode of high work function and a second electrode of low work function with a hole conducting layer interposed between the electroluminescent layer and the transparent high work function electrode and an electron conducting layer interposed between the electroluminescent layer and the electron injecting low work function anode. The hole conducting layer and the electron conducting layer are required to improve the working and the efficiency of the device. The hole transporting layer serves to transport holes and to block the electrons, thus preventing electrons from moving into the electrode without recombining with holes. The recombination of carriers therefore mainly takes place in the emitter layer.

We have now invented a method of making an electroluminescent device using an ink jet printing technique.

According to the invention there is provided a method of forming an electroluminescent device in which an electroluminescent material is deposited on a substrate by ink jet printing.

A review of ink jet technology is provided in Journal of Imaging Science and Technology 42:49-62 (1998).

Ink-jet is a non-impact dot-matrix printing technology in which droplets of ink are jetted from a small aperture directly to a specified position on a media to create an image. Ink-jet printing has been implemented in many different designs and has a wide range of potential applications. Fundamentally, ink-jet printing is divided into the continuous and the drop-on-demand ink-jet methods. In the early 1960s, Dr. Sweet of Stanford University demonstrated that by applying a pressure wave pattern to an orifice, the ink stream could be broken into droplets of uniform size and spacing. When the drop break-off mechanism was controlled, an electric charge could be impressed on the drops selectively and reliably as they formed out of the continuous ink stream. The charged drops when passing through the electric field were deflected into a gutter for recirculation, and those uncharged drops could fly directly onto the media to form an image.⁴ This printing process is known as a continuous ink-jet.

Depending on the drop deflection methodology, the continuous ink-jet can be designed as a binary or multiple deflection system. In a binary deflection system, the drops are either charged or uncharged. The charged drops are allowed to fly directly onto the media, while the uncharged drops are deflected into a gutter for recirculation. In a multiple deflection system, drops are charged and deflected to the media at different levels. The uncharged drops fly straight to a gutter to be recirculated.

While continuous ink-jet development was intense, the development of a drop-on-demand ink-jet method was also popularised. A drop-on-demand device ejects ink droplets only when they are used in imaging on the media. This approach eliminates the complexity of drop charging and deflection hardware as well as the inherent unreliability of the ink recirculation systems required for the continuous ink-jet technology.

There are presently two main types of ink jet printing being utilized, thermal and piezo. In both types, drops of liquid are dispelled from jet nozzles. Of these printing technologies, thermal ink jet printing has been developed first and is the dominant technology employed. Thermal ink jet printing, also known as “drop on demand”, employs a process of super-heating the ink inside the print cartridge to about 400 degrees. As the ink heats up, vapour bubbles are formed inside the cartridge, which expand, explode, and then force ultra-fine droplets of ink out of the printhead's micron-size nozzles and onto the media. As the ink leaves the nozzle head, it creates a vacuum that pulls in fresh ink. This process is repeated thousands of times per second. Thermal ink jet printers are described in U.S. Pat. Nos. 4,463,359 4,463,359 4,275,290 and nozzle configurations are described in U.S. Pat. Nos. 4,106,976 to 4,157,935.

Piezo ink jet printing relies on different principles for the expulsion of ink from the cartridge nozzles. With this technology, an electrical charge is applied to the cartridge nozzles and excites a small piezo crystal that is inside. When the piezoelectric crystals are stimulated, the crystals change shape and squeeze the ink chamber. This action is similar to the action of squeezing an oil can, and forcefully expels the ink from the nozzle tip.

Since the piezoelectric process does not utilize heat, printheads can use a wider range of inks than thermal inkjet printers because the heat is removed from the process. This means that solvent-based ink systems and pigmented-ink formulations will be more readily available, which increases the development capabilities for better inks in the future.

In the piezoelectric ink-jet, depending on the piezoceramic deformation mode the technology can be classified into four main types: squeeze, bend, push, and shear. A squeeze-mode ink-jet can be designed with a thin tube of piezoceramic surrounding a glass nozzle or with a piezoceramic tube cast in plastic that encloses the ink channel.

In a typical bend-mode design the piezoceramic plates are bonded to the diaphragm forming an array of bilaminar electromechanical transducers used to eject the ink droplets. In a push-mode design as the piezoceramic rods expand, they push against ink to eject the droplets. In theory, piezodrivers can directly contact and push against the ink. However, in practical implementation, a thin diaphragm between piezodrivers and ink is incorporated to prevent the undesirable interactions between ink and piezodriver materials.

In both the bend- and push-mode designs, the electric field generated between the electrodes is in parallel with the polarization of the piezomaterial. In a shear-mode printhead, the electric field is designed to be perpendicular to the polarization of the piezodriver. The shear action deforms the piezoplates against ink to eject the droplets. In this case, the piezodriver becomes an active wall in the ink chamber. Interaction between ink and piezomaterial is one of the key parameters of a shear-mode printhead design.

Most, if not all, of the drop-on-demand ink-jet printers on the market today are using either the thermal or piezoelectric principle. Both the electrostatic ink-jet and acoustic ink-jet methods are still in the development stage with many patents pending and few commercial products available.

Another approach to obtaining better image quality without relying on special media is the use of solid ink (or hot melt or phase-change ink) which is solid at room temperature. In operation, the ink is jetting as molten liquid drops. Phase-change ink is also called hot melt or solid ink. The ink is jetted out from the printhead as a molten liquid. Upon hitting a recording surface, the molten ink drop solidifies immediately, thus preventing the ink from spreading or penetrating the printed media.

A list of references covering aspects of ink jet printing and printers is given at the end of the specification.

A typical electroluminescent device will comprise (i) a first electrode, (ii) a hole transporting layer (iii) a layer consisting of an electroluminescent material, (iv) an electron transporting layer and (v) a second electrode.

Each of the layers can be deposited by ink jet printing or only the electroluminescent layer. Depending on the nature of the material to be deposited, any of the known ink jet printing methods e.g. as referred to above can be used. When the material to be deposited is a solid the continuous and the drop-on-demand ink-jet methods and Piezo ink jet printing can be used if the material to be deposited is in the form of a solution in a solvent. The solvent which is used will depend on the material but chlorinated hydrocarbons such as dichloromethane, n-methyl pyrrolidone, dimethyl sulphoxide, tetrahydrofuran dimethylformamide etc. are suitable in many

Alternatively the use of solid ink (or hot melt or phase-change ink) process in which the material, which is solid at room temperature is jetted as molten liquid drops on to the substrate can be used.

The ink jet printing can be used to deposit controlled amounts of the material to be deposited and can be controlled to deposit the material in the precise location.

When mixed materials are to be deposited a mixture of the materials is placed in the cartridge of the ink jet printer. The deposition can take place in a vacuum or other atmosphere is desired.

The electroluminescent compounds which can be used as the electroluminescent materials in the present invention are of general formula (Lα)ₙM where M is a rare earth, lanthanide or an actinide, Lα is an organic complex and n is the valence state of M.

Preferred electroluminescent compounds which can be used in the present invention are of formula 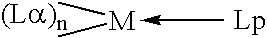
where Lα and Lp are organic ligands, M is a rare earth, transition metal, lanthanide or an actinide and n is the valence state of the metal M. The ligands Lα can be the same or different and there can be a plurality of ligands Lp which can be the same or different.

For example (L₁)(L₂)(L₃)(L . .)M (Lp) where M is a rare earth, transition metal, lanthanide or an actinide and (L₁)(L₂)(L₃)(L . . .) are the same or different organic complexes and (Lp) is a neutral ligand. The total charge of the ligands (L₁)(L₂)(L₃)(L . .) is equal to the valence state of the metal M. Where there are 3 groups Lα which corresponds to the III valence state of M the complex has the formula (L₁)(L₂)(L₃)M (Lp) and the different groups (L₁)(L₂)(L₃) may be the same or different.

Lp can be monodentate, bidentate or polydentate and there can be one or more ligands Lp.

Preferably M is metal ion having an unfilled inner shell and the preferred metals are selected from Sm(III), Eu(II), Eu(III), Tb(III), Dy(III), Yb(III), Lu(III), Gd (III), Gd(III) U(III), Tm(III), Ce (III), Pr(III), Nd(III), Pm(III), Dy(III), Ho(III), Er(III) and more preferably Eu(III), Tb(III), Dy(III), Gd (III).

Further electroluminescent compounds which can be used in the present invention are of general formula (Lα)ₙM₁M₂ where M₁ is the same as M above, M₂ is a non rare earth metal; Lα is a as above and n is the combined valence state of M₁ and M₂. The complex can also comprise one or more neutral ligands Lp so the complex has the general formula (Lα)ₙ M₁ M₂ (Lp), where Lp is as above. The metal M₂ can be any metal which is not a rare earth, transition metal, lanthanide or an actinide examples of metals which can be used include lithium, sodium, ,potassium, rubidium, caesium, beryllium, magnesium, calcium, strontium, barium, copper (I), copper (II), silver, gold, zinc, cadmium, boron, aluminium, gallium, indium, germanium, tin (II), tin (IV), antimony (II), antimony (IV), lead (II), lead (IV) and metals of the first, second and third groups of transition metals in different valence states e.g. manganese, iron, ruthemium, osmium, cobalt, nickel, palladium(II), palladium(IV), platinum(II), platinum(IV), cadmium, chromium, titanium, vanadium, zirconium, tantulum, molybedenum, rhodium, iridium, titanium, niobium, scandium, yttrium.

For example, (L₁)(L₂)(L₃)(L . .)M (Lp) where M is a rare earth, transition metal, lanthanide or an actinide and (L₁)(L₂)(L₃)(L . . .) and (Lp) are the same or different organic complexes.

Further organometallic complexes which can be used in the present invention are binuclear, trinuclear and polynuclear organometallic complexes e.g. of formula 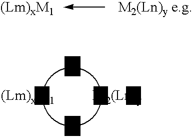
where L is a bridging ligand and where M₁ is a rare earth metal and M₂ is M₁ or a non rare earth metal, Lm and Ln are the same or different organic ligands Lα as defined above, x is the valence state of M₁ and y is the valence state of M₂.

In these complexes there can be a metal to metal bond or there can be one or more bridging ligands between M₁ and M₂ and the groups Lm and Ln can be the same or different.

By trinuclear is meant there are three rare earth metals joined by a metal to metal bond i.e. of formula 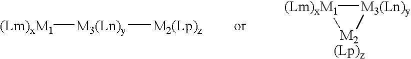
where M₁, M₂ and M₃ are the same or different rare earth metals and Lm, Ln and Lp are organic lignads Lα and x is the valence state of M₁, y is the valence state of M₂ and z is the valence state of M₃. Lp can be the same an Lm and Ln or different.

The rare earth metals and the non rare earth metals can be joined together by a metal to metal bond and/or via an intermediate bridging atom, ligand or molecular group.

For example the metals can be linked by bridging ligands e.g. 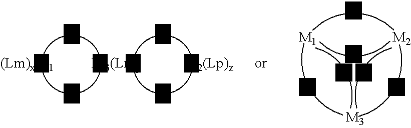
where L is a bridging ligand.

By polynuclear is meant there are more than three metals joined by metal to metal bonds and/or via intermediate ligands. 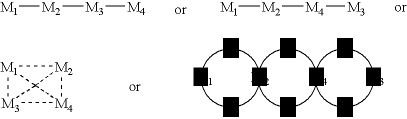
where M₁, M₂, M₃ and M₄ are rare earth metals and L is a bridging ligand.

The metal M₂ can be any metal which is not a rare earth, transition metal, lanthanide or an actinide examples of metals which can be used include lithium, sodium, potassium, rubidium, caesium, beryllium, magnesium, calcuim, strontium, barium, copper, silver, gold, zinc, cadmium, boron, aluminium, gallium, indium, germanium, tin, antimony, lead, and metals of the first, second and third groups of transition metals e.g. manganese, iron, ruthenium, osmium, cobalt, nickel, palladium, platinum, cadmium, chromium, titanium, vanadium, zirconium, tantulum, molybdenum, rhodium, iridium, titanium, niobium, scandium, yttrium etc.

Preferably Lα is selected from β dilketones such as those of formulae 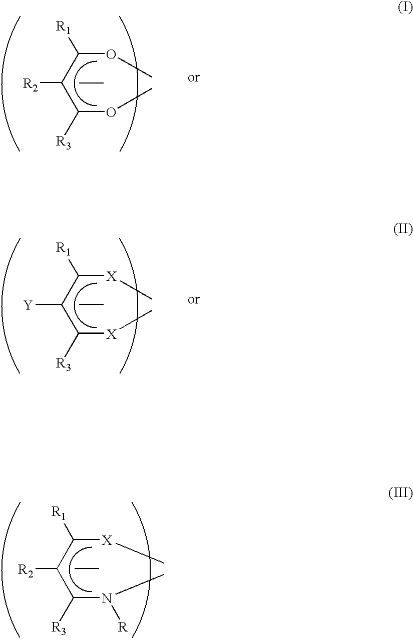
where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiopheny groups; R₁, R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

Some of the different groups L may also be the same or different charged groups such as carboxylate groups so that the group L₁ can be as defined above and the groups L₂, L₃ . . . can be charged groups such as 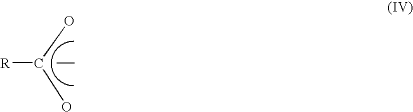
where R is R₁ as defined above or the groups L₁, L₂ can be as defined above and L₃ . . . etc. are other charged groups.

R₁, R₂ and R₃ can also be 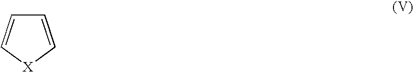
where X is O, S, Se or NH.

A preferred moiety R₁ is trifluoromethyl CF₃ and examples of such diketones are, banzoyltrifluoroacetone, p-chlorobenzoyltrifluoroacetone, p-bromotrifluoroacetone, p-phenyltrifluoroacetone, 1-naphthoyltrifluoroacetone, 2-naphthoyltrifluoroacetone, 2-phenathoyltrifluoroacetone, 3-phenanthoyltrifluoroacetone, 9-anthroyltrifluoroacetonetrifluoroacetone, cinnamoyltrifluoroacetone, and 2-thenoyltrifluoroacetone.

The different groups L may be the same or different ligands of formulae 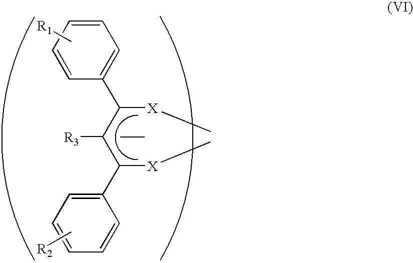
where X is O, S, and Se and R₁ R₂ and R₃ are as above.

The different groups L may be the same or different quinolate derivatives such as 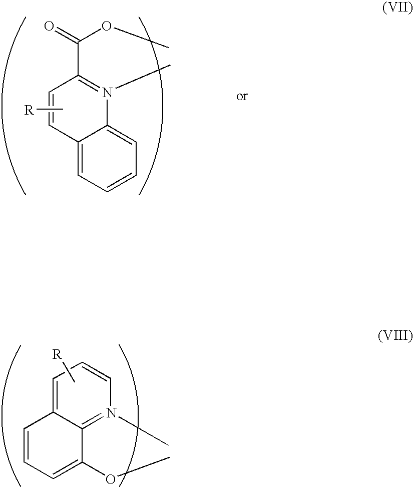
where R is hydrocarbyl, aliphatic, aromatic or heterocyclic carboxy, aryloxy, hydroxy or alkoxy e.g. the 8 hydroxy quinolate derivatives or 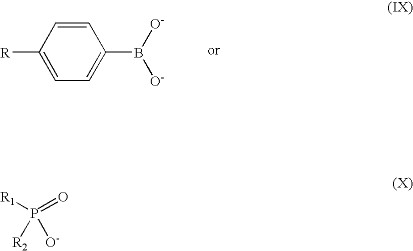
where R, R₁, and R₂ are as above or are H or F e.g. R₁ and R₂ are alkyl or alkoxy groups

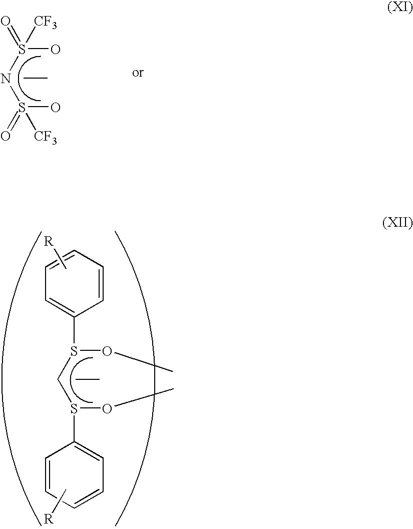

As stated above the different groups L may also be the same or different carboxylate groups e.g. 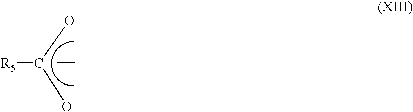
where R₅ is a substituted or unsubstituted aromatic, polycyclic or heterocyclic ring a polypyridyl group, R₅ can also be a 2-ethyl hexyl group so Lₙ is 2-ethylhexanoate or R₅ can be a chair structure so that Lₙ is 2-acetyl cyclohexanoate or Lα can be 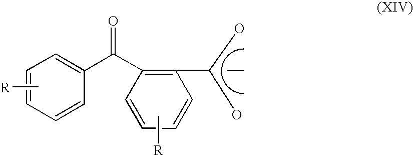
where R is as above e.g. alkyl, allenyl, amino or a fused ring such as a cyclic or polycyclic ring.

The different groups L may also be 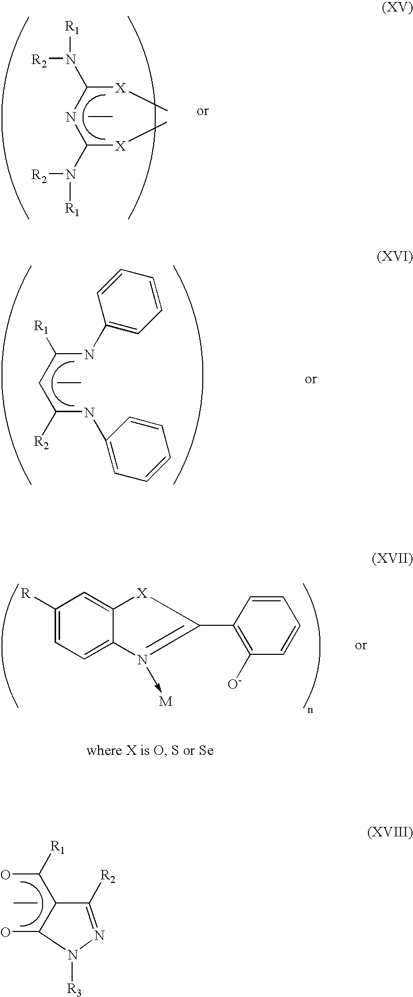
Where R, R₁ and R₂ are as above or

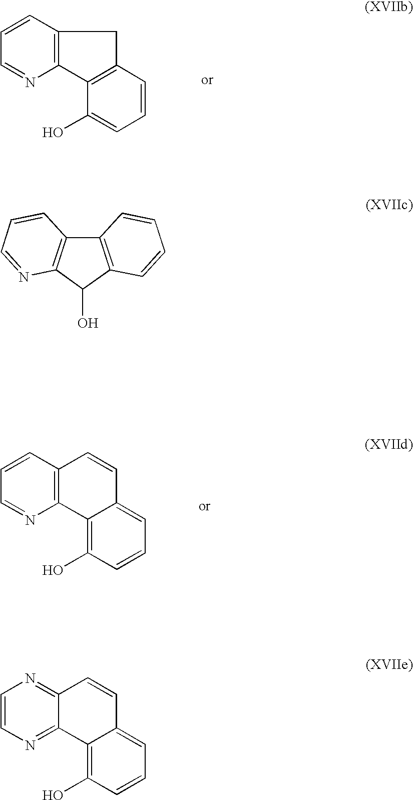

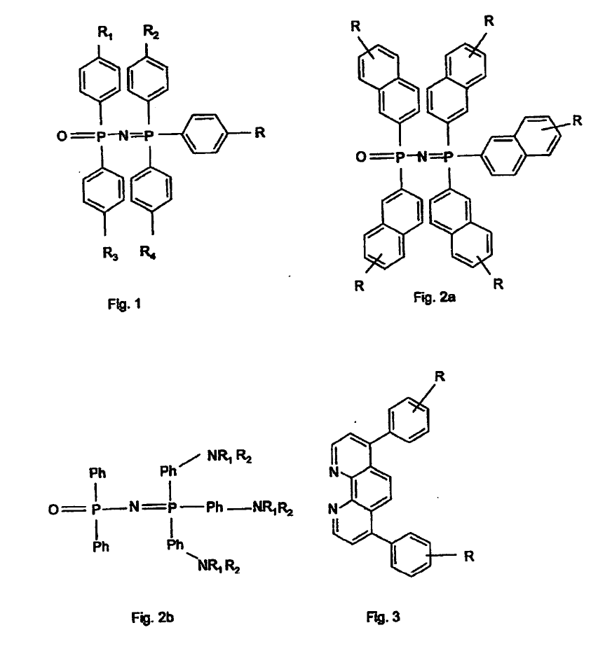

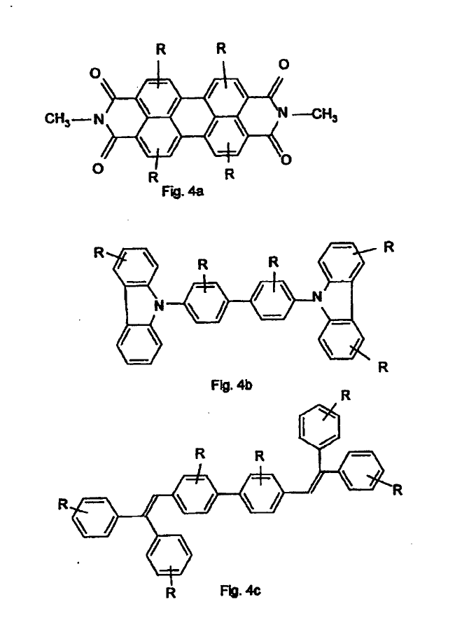

The groups L_{P} can be selected from 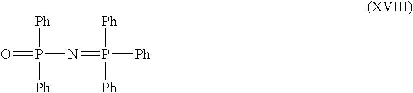
Where each Ph which can be the same or different and can be a phenyl (OPNP) or a substituted phenyl group, other substituted or unsubstituted aromatic group, a substituted or unsubstituted heterocyclic or polycyclic group, a substituted or unsubstituted fused aromatic group such as a naphthyl, anthracene, phenanthrene or pyrene group. The substituents can be for example an alkyl, aralkyl, alkoxy, aromatic, heterocyclic, polycyclic group, halogen such as fluorine, cyano, amino. Substituted amino etc. Examples are given in FIGS. 1 and 2 of the drawings where R, R₁, R₂, R₃ and R₄ can be the same or different and are selected from hydrogen, hydrocarbyl groups, substituted and unsubstituted aromatic, heterocyclic and polycyclic ring structures, fluorocarbons such as trifluoryl methyl groups, halogens such as fluorine or thiophenyl groups; R, R₁, R₂, R₃ and R₄ can also form substituted and unsubstituted fused aromatic, heterocyclic and polycyclic ring structures and can be copolymerisable with a monomer e.g. styrene. R, R₁, R₂, R₃ and R₄ can also be unsaturated alkylene groups such as vinyl groups or groups 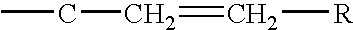
where R is as above.

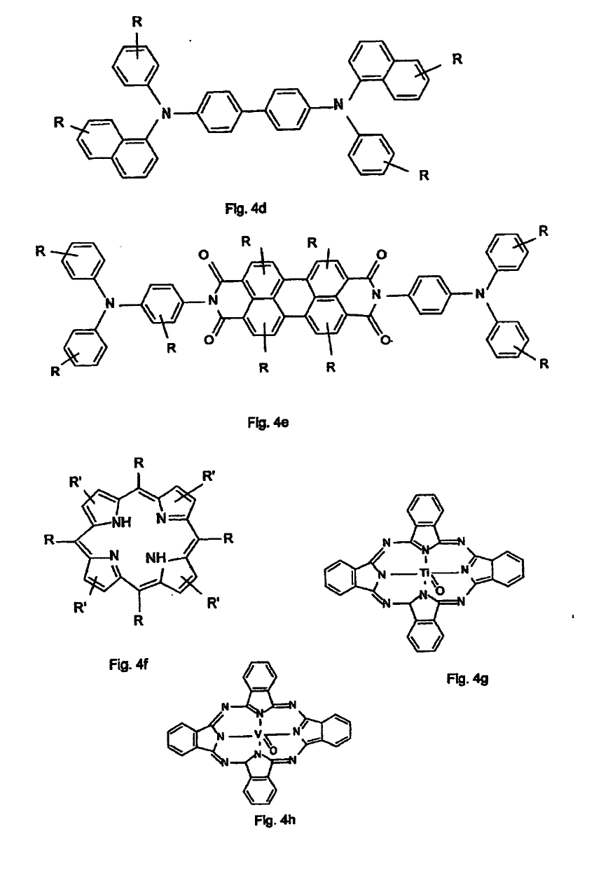

Lₚ can also be compounds of formulae 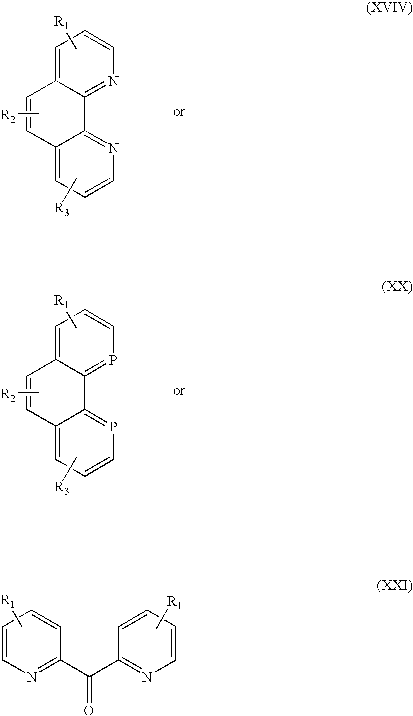
where R₁, R₂ and R₃ are as referred to above, for example bathophen shown in FIG. 3 of the drawings in which R is as above or 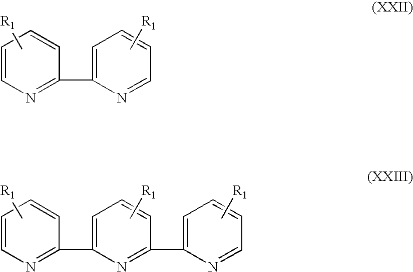
where R₁, R₂ and R₃ are as referred to above.

Lₚ can also be 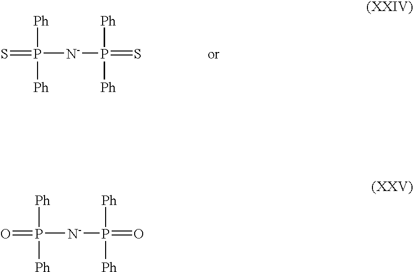
where Ph is as above.

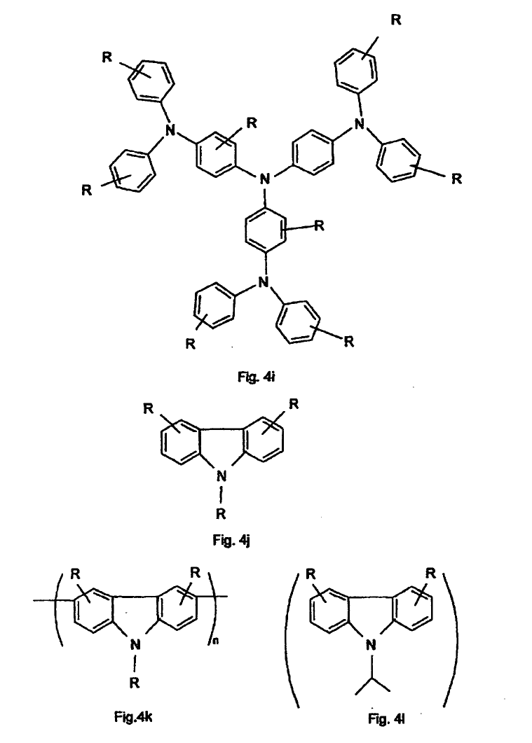

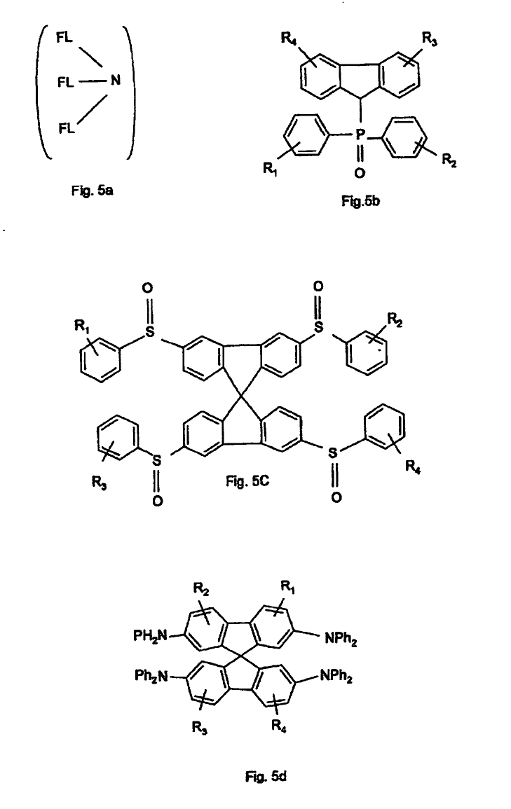

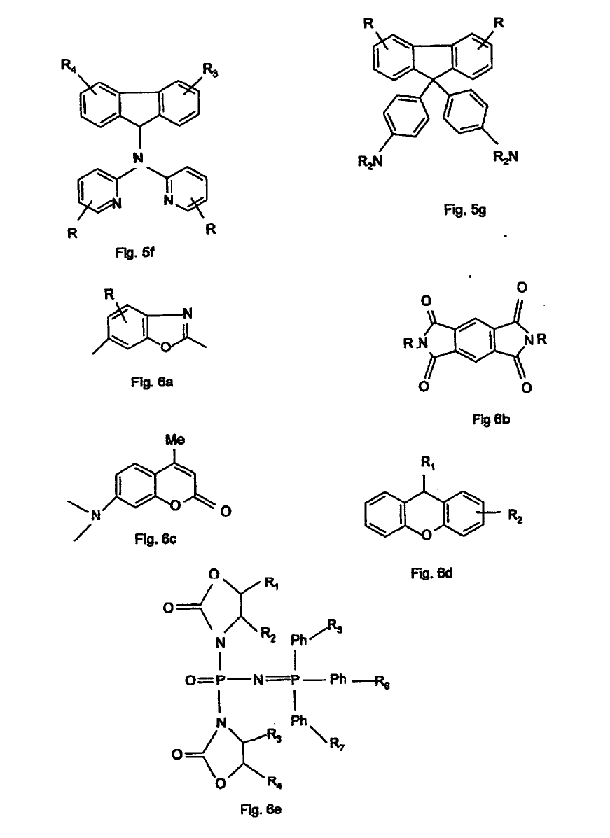

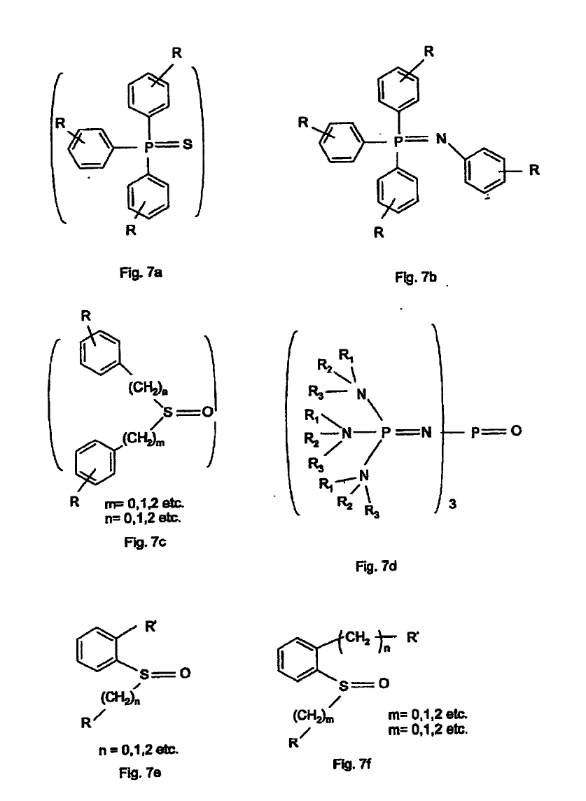

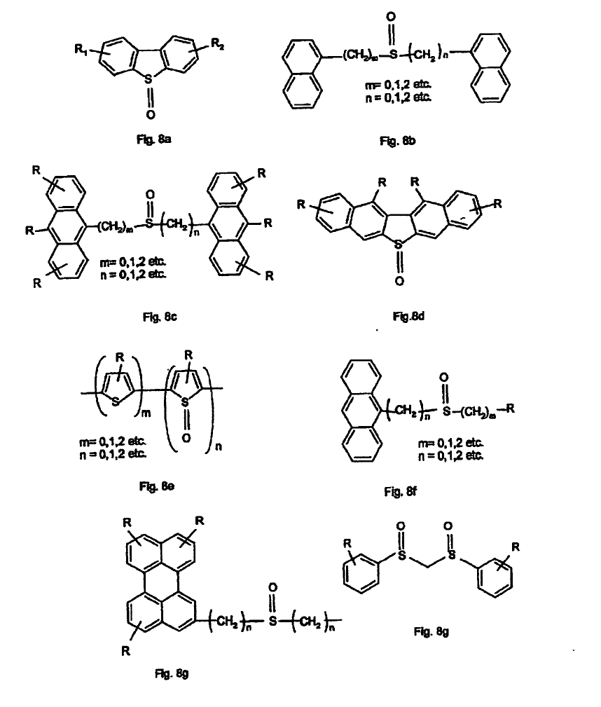

Other examples of Lₚ chelates are as shown in FIG. 4 and fluorene and fluorene derivatives e.g. a shown in FIG. 5 and compounds of formulae as shown as shown in FIGS. 6 to 8.

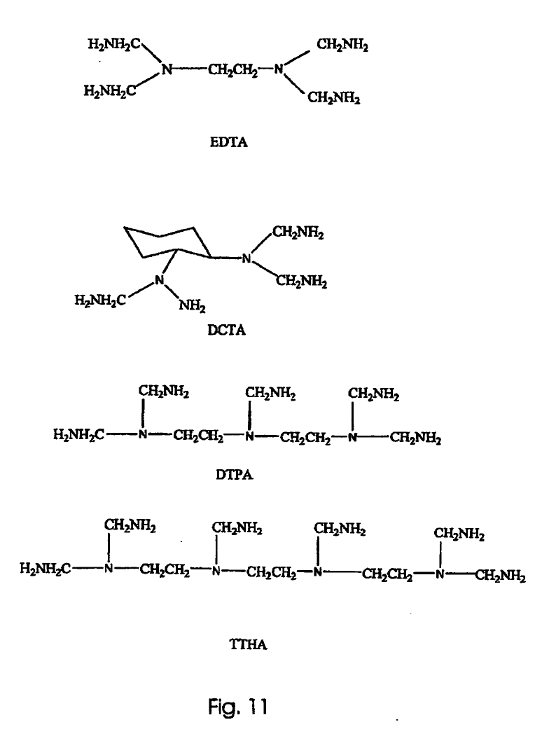

Specific examples of Lα and Lp are tripyridyl and TMHD, and TMHD complexes, α, α′, α″ tripyridyl, crown ethers, cyclans, crytptans phthalocyanas, porphoryins ethylene diamine tetramine (EDTA), DCTA, DTPA and TTHA. Where TMHD is 2,2,6,6-tetramethyl-3,5-heptanedionato and OPNP is diphenylphosphonimide triphenyl phosphorane. The formulae of the polyamines are shown in FIG. 11.

Other electroluminescent materials which can be used include metal quinolates such as lithium quinolate, and non rare earth metal complexes such as aluminium, magnesium, zinc and scandium complexes such as complexes of β-diketones e.g. Tris-(1,3-diphenyl-1-3-propenedione) (DBM) and suitable metal complexes are Al(DBM)₃, Zn(DBM)₂ and suitable metal complexes are Al(DBM)₃, Zn(DBM)₂ and Mg(DBM)₂, Sc(DBM)₃ etc.

The first electrode is preferably a transparent substrate such as is a conductive glass or plastic material which acts as the anode, preferred substrates are conductive glasses such as indium tin oxide coated glass, but any glass which is conductive or has a conductive layer such as a metal or conductive polymer can be used. Conductive polymers and conductive polymer coated glass or plastics materials can also be used as the substrate.

The hole transporting material can be an amine complex such as poly (vinylcarbazole) N, N′-diphenyl-N,N′-bis (3-methylphenyl)-1,1′-biphenyl-4,4′-diamine (TPD), an unsubstituted or substituted polymer of an amino substituted aromatic compound, a polyaniline, substituted polyanilines, polythiophenes, substituted polythiophenes, polysilanes etc. Examples of polyanilines are polymers of 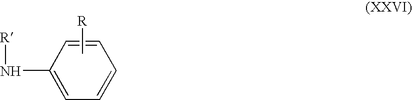
where R is in the ortho—or meta-position and is hydrogen, C1-18 alkyl, C1-6alkoxy, amino, chloro, bromo, hydroxy or the group 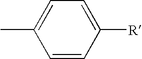
where R is alky or aryl and R′ is hydrogen, C1-6 alkyl or aryl with at least one other monomer of formula I above.

Or the hole transporting material can be a polyaniline, polyanilines which can be used in the present invention have the general formula 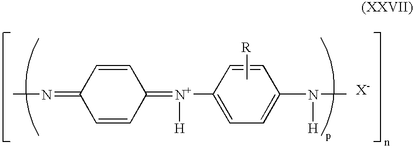
where p is from 1 to 10 and n is from 1 to 20, R is as defined above and X is an anion, preferably selected from Cl, Br, SO₄, BF₄, PF₆, H₂PO₃, H₂PO₄, arylsulphonate, arenedicarboxylate, polystyrenesulphonate, polyacrylate alkysulphonate, vinylsulphonate, vinylbenzene sulphonate, cellulose sulphonate, camphor sulphonates, cellulose sulphate or a perfluorinated polyanion.

Examples of arylsulphonates are p-toluenesulphonate, benzenesulphonate, 9,10-anthraquinone-sulphonte and anthracensulphonate, an example of an arenedicarboxylate is phthalate and an example of arenecarboxylate is benzoate.

We have found that protonated polymers of the unsubstituted or substituted polymer of an amino substituted aromatic compound such as a polyaniline are difficult to evaporate or cannot be evaporated, however we have surprisingly found that if the unsubstituted or substituted polymer of an amino substituted aromatic compound is deprotonated the it can be easily evaporated i.e. the polymer is evaporable.

Preferably evaporable deprotonated polymers of unsubstituted or substituted polymer of an amino substituted aromatic compound are used. The de-protonted unsubstituted or substituted polymer of an amino substituted aromatic compound can be formed by deprotonating the polymer by treatment with an alkali such as ammonium hydroxide or an alkali metal hydroxide such as sodium hydroxide or potassium hydroxide.

The degree of protonation can be controlled by forming a protonated polyaniline and de-protonating. Methods of preparing polyanilines are described in the article by A. G. MacDiarmid and A. F Epstein, Faraday Discussions, Chem Soc. 88 P319 1989.

The conductivity of the polyaniline is dependant on the degree of protonation with the maximum conductivity being when the degree of protonation is between 40 and 60% e.g. about 50% for example.

Preferably the polymer is substantially fully deprotonated.

A polyaniline can be formed of octamer units i.e. p is four e.g.

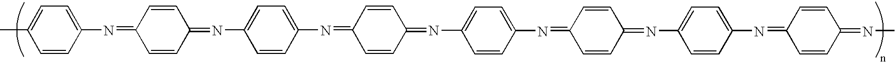

The polyanilines can have conductivities of the order of 1 ×10⁻¹ Siemen cm⁻¹ or higher.

The aromatic rings can be unsubstituted or substituted e.g. by a C1 to 20 alkyl group such as ethyl.

The polyaniline can be a copolymer of aniline and preferred copolymers are the copolymers of aniline with o-anisidine, m-sulphanilic acid or o-aminophenol, or 0-toluidine with o-aminophenol, o-ethylaniline, o-phenylene diamine or with amino anthracenes.

Other polymers of an amino substituted aromatic compound which can be used include substituted or unsubstituted polyaminoapthalenes, polyaminoanthracenes, polyaminophenanthrenes, etc. and polymers of any other condensed polyaromatic compound. Polyaminoanthracenes and methods of making them are disclosed in U.S. Pat. No. 6,153,726. The aromatic rings can be unsubstituted or substituted e.g. by a group R as defined above.

Other hole transporting materials are conjugated polymer and the conjugated polymers which can be used can be any of the conjugated polymers disclosed or referred to in U.S. Pat. No. 5,807,627, PCT/WO90/13148 and PCT/WO92/03490.

The preferred conjugated polymers are poly (p-phenylenevinylene)-PPV and copolymers including PPV. Other preferred polymers are poly(2,5 dialkoxyphenylene vinylene) such as poly (2-methoxy-5-(2-methoxypentyloxy)-1,4-phenylene vinylene), poly(2-methocypentyloxy-1,4-phenylenevinylene), poly(2-methoxy-5-(2-dodecyloxy-1,4-phenylvenevinylene) and other poly(2,5 dialkoxyphenylenevinylenes) with at least one of the alkoxy groups being a long chain solubilising alkoxy group, poly fluorenes and oligofluorenes, polyphenylenes and oligophenylenes, polyanthracenes and oligo anthracenes, ploythiophenes and oligothiophenes.

In PPV the phenylene ring may optionally carry one or more substitutents e.g. each independently selected from alkyl, preferably methyl, alkoxy, preferably methoxy or ethoxy.

Any poly(arylenevinylene) including substituted derivatives thereof can be used and the phenylene ring in poly(p-phenylenevinylene) may be replaced by a fused ring system such as anthracene or naphthlyene ring and the number of vinylene groups in each polyphenylenevinylene moiety can be increased e.g. up to 7 or higher.

The conjugated polymers can be made by the methods disclosed in U.S. Pat. No. 5,807,627, PCT/WO90/13148 and PCT/WO92/03490.

The thickness of the hole transporting layer is preferably 20 nm to 200 nm.

The polymers of an amino substituted aromatic compound such as polyanilines referred to above can also be used as buffer layers with or in conjunction with other hole transporting materials.

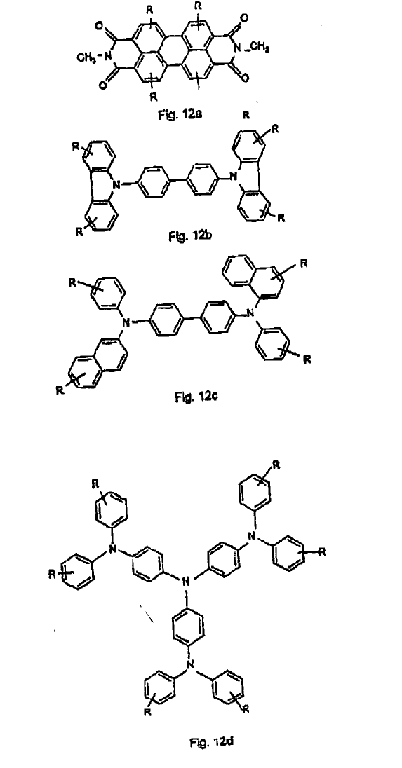

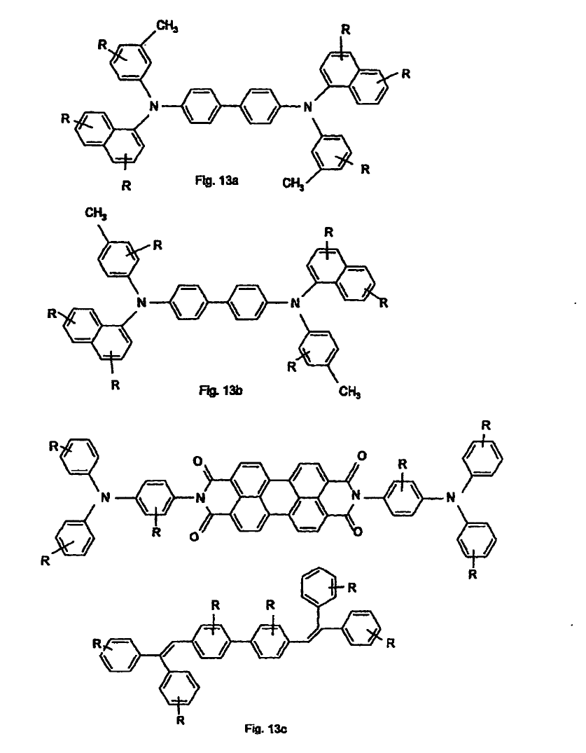

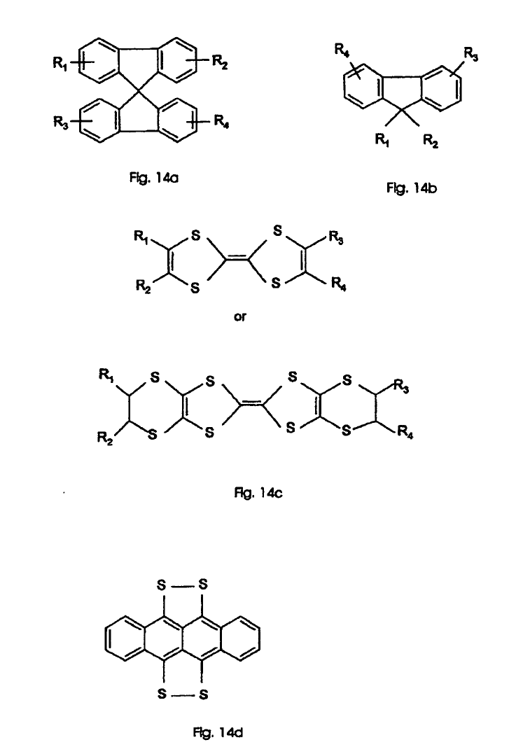

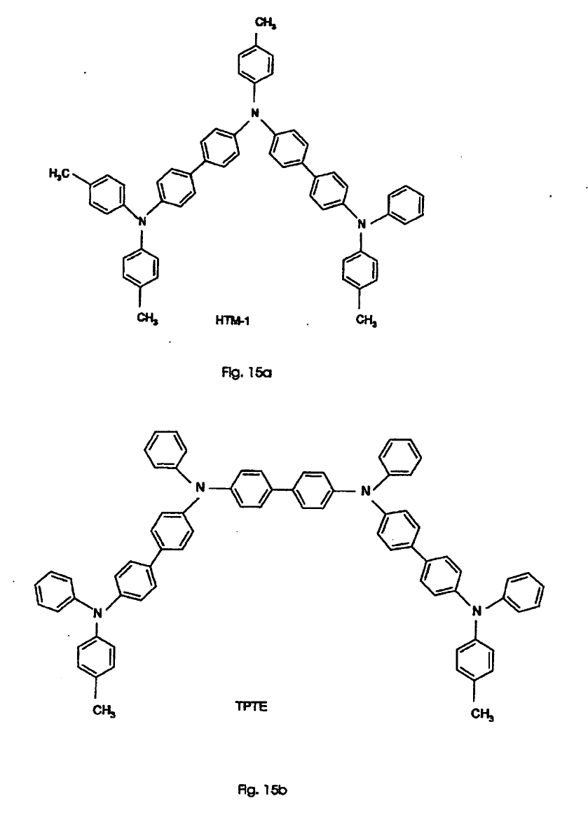

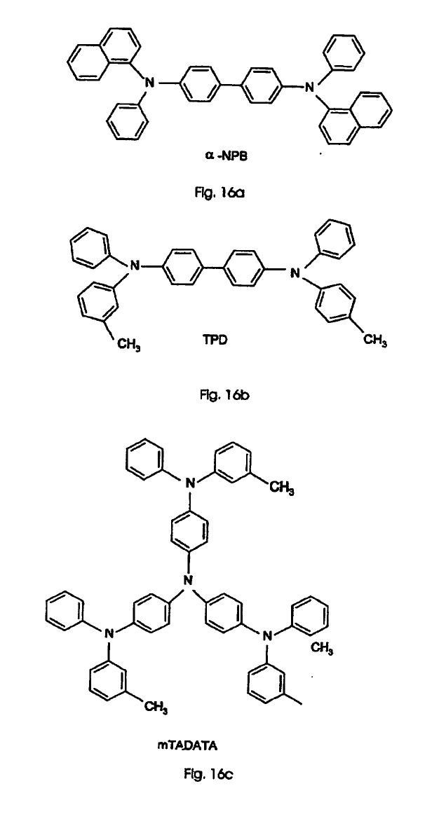

The structural formulae of some other hole transporting materials are shown in FIGS. 12, 13, 14, 15 and 16 of the drawings, where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include alphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

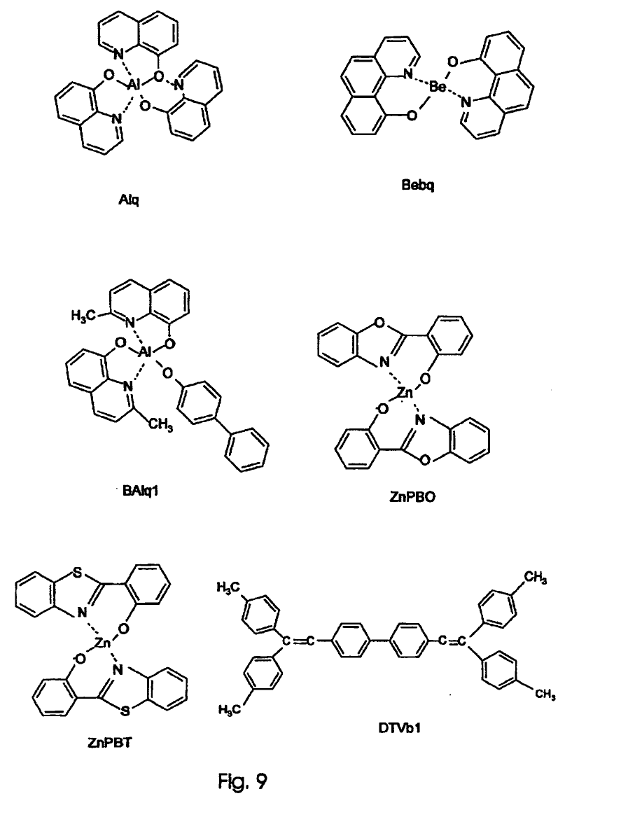

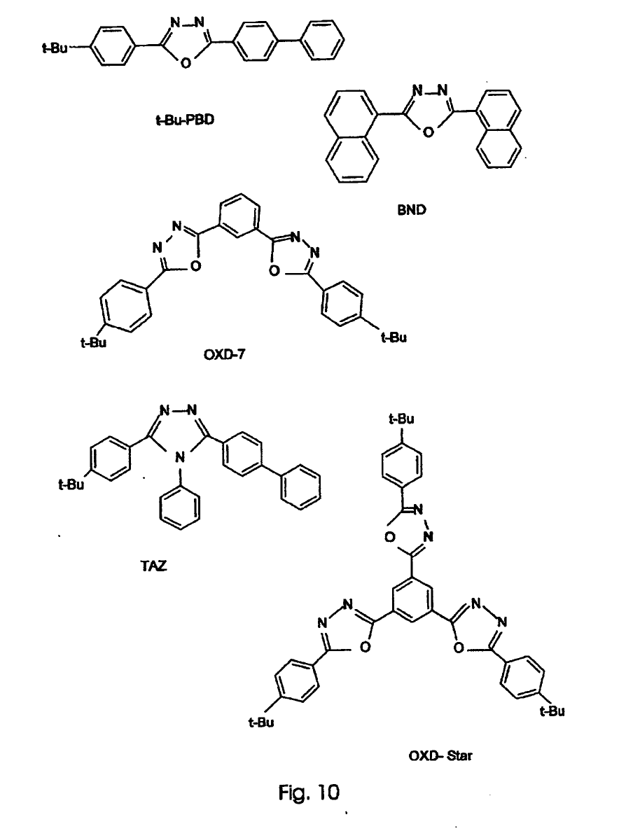

Optionally there is a layer of an electron injecting material between the cathode and the electroluminescent material layer, the electron injecting material is a material which will transport electrons when an electric current is passed through electron injecting materials include a metal complex such as a metal quinolate e.g. an aluminium quinolate, lithium quinolate, a cyano anthracene such as 9,10 dicyano anthracene, cyano substituted aromatic compounds, tetracyanoquinidodimethane a polystyrene sulphonate or a compound with the structural formulae shown in FIGS. 9 and 10 of the drawings in which the pheny rings can be substituted with substituents R as defined above. Instead of being a separate layer the electron injecting material can be mixed with the electroluminescent material and co-deposited with it.

The second electrode functions as the cathode and can be any low work function metal e.g. aluminium, calcium, lithium, silver/magnesium alloys, rare earth metal alloys etc., aluminium is a preferred metal. A metal fluoride such as an alkali metal, rare earth metal or their alloys can be used as the second electrode for example by having a metal fluoride layer formed on a metal.

Optionally the hole transporting material can be mixed with the electroluminescent material and co-deposited with it.

The hole transporting material, the electroluminescent material and the electron injecting materials can be mixed together to form one layer, which simplifies the construction.

The display of the invention may be monochromatic or polychromatic. Electroluminescent rare earth chelate compounds are known which will emit a range of colours e.g. red, green, and blue light and while light and examples are disclosed in Patent Application Nos. WO98/58037 PCT/GB98/01773, PCT/GB99/03619, PCT/GB99/04030, PCT/GB99/04024, PCT/GB99/104028, PCT/GB00/00268 and can be used to form OLEDs emitting those colours. Thus, a full colour display can be formed by arranging three individual backplanes, each emitting a different primary monochrome colour, on different sides of an optical system, from another side of which a combined colour image can be viewed. Alternatively, rare earth chelate electroluminescent compounds emitting different colours can be fabricated so that adjacent diode pixels in groups of three neighbouring pixels produce red, green and blue light. In a further alternative, field sequential colour filters can be fitted to a white light emitting display.

Either or both electrodes can be formed of silicon and the electroluminescent material and intervening layers of a hole transporting and electron transporting materials can be formed as pixels on the silicon substrate. Preferably each pixel comprises at least one layer of a rare earth chelate electroluminescent material and an (at least semi-) transparent electrode in contact with the organic layer on a side thereof remote from the substrate.

Preferably, the substrate is of crystalline silicon and the surface of the substrate may be polished or smoothed to produce a flat surface prior to the deposition of electrode, or electroluminescent compound. Alternatively a non-planarised silicon substrate can be coated with a layer of conducting polymer to provide a smooth, flat surface prior to deposition of further materials.

In one embodiment, each pixel comprises a metal electrode in contact with the substrate. Depending on the relative work functions of the metal and transparent electrodes, either may serve as the anode with the other constituting the cathode.

When the silicon substrate is the cathode an indium tin oxide coated glass can act as the anode and light is emitted through the anode. When the silicon substrate acts as the anode the cathode can be formed of a transparent electrode which has a suitable work function, for example by a indium zinc oxide coated glass in which the indium zinc oxide has a low work function. The anode can have a transparent coating of a metal formed on it to give a suitable work function. These devices are sometimes referred to as top emitting devices or back emitting devices.

The metal electrode may consist of a plurality of metal layers, for example a higher work function metal such as aluminium deposited on the substrate and a lower work function metal such as calcium deposited on the higher work function metal. In another example, a further layer of conducting polymer lies on top of a stable metal such as aluminium.

Preferably, the electrode also acts as a mirror behind each pixel and is either deposited on, or sunk into, the planarised surface of the substrate. However, there may alternatively be a light absorbing black layer adjacent to the substrate.

In still another embodiment, selective regions of a bottom conducting polymer layer are made non-conducting by exposure to a suitable aqueous solution allowing formation of arrays of conducting pixel pads which serve as the bottom contacts of the pixel electrodes.

As described in WO00/60669 the brightness of light emitted from each pixel is preferably controllable in an analogue manner by adjusting the voltage or current applied by the matrix circuitry or by inputting a digital signal which is coverted to an analogue signal in each pixel circuit. The substrate preferably also provides data drivers, data converters and scan drivers for processing information to address the array of pixels so as to create images. When an electroluminescent material is used which emits light of a different colour depending on the applied voltage the colour of each pixel can be controlled by the matrix circuitry.

In one embodiment, each pixel is controlled by a switch comprising a voltage controlled element and a variable resistance element, both of which are conveniently formed by metal-oxide-semiconductor field effect transistors (MOSFETs) or by an active matrix transistor.

### REFERENCES

1. F. R. S. Rayleigh, On the instability of jets, in Proc. London Math. Soc. 10 (4), 4-13 (1878).

2. R. Elmqvist, Measuring instrument of the recording type, U.S. Pat. No. 2,566,443 (1951).

3. R. G. Sweet, High frequency recording with electrostatically deflected ink-jets, Rev. Sci. Instrum. 36, 131 (1965).

4. R. G. Sweet, Signal apparatus with fluid drop recorder, U.S. Pat. No. 3,596,275 (1971).

5. W. L. Buehner, J. D. Hill, T. H. Williams, and J. W. Woods, Application of ink-jet technology to a word processing output printer, IBM J. Res. Dev. 21 (1968-1977).

6. C. H. Hertz and S. I. Simonsson, Ink-jet recorder, U.S. Pat. No. 3,416,153 (1968).

7. J. Heinzl, Printing with ink droplets from a multi-nozzle device, in Adv. in Non-Impact Printing Technologies for Computer and Office Applications, Joseph Gaynor, Ed., 1981, pp. 1191-1201.

8. S. L. Zoltan, (Clevite Corp.), Pulse droplet ejection system, U.S. Pat. No. 3,683,212 (1974).

9. E. L. Kyser and S. B. Sears, (Silonic Inc.), Method and apparatus for recording with writing fluids and drop projection means therefore, U.S. Pat. No. 3,946,398 (1976).

10. I. Endo, Y. Sato, S. Saito, T. Nakagiri, and S. Ohno, (Canon) Liquid jet recording process and apparatus there for, Great Britain Patent 2007162 (1979).

11. J. L. Vaught, F. L. Cloutier, D. K. Donald, J. D. Meyer, C. A. Taclind, and H. H. Taub, (Hewlett-Packard), Thermal ink-jet printer, U.S. Pat. No. 4,490,728 (1984).

12. C. R. Winston, (Teletype), Method and apparatus for transferring ink, U.S. Pat. No. 3,060,429 (1962).

13. S. Howskin, Physical limitation on high performance piezo-electric pusher technology, Proc. SPIE 1912, 142-151 (1992).

14. R. Howard, R. R. Helinski and H. E. Manhannett, (Howtek), Ink-jet color printing, European Patent Application 0 187 352 (1985).

15. J. Heinzl and C. H. Hertz, Ink-jet printing, Adv. Electronics and Electron Physics 65, 91 (1985).

16. F. J. Kamphoefner, Ink-jet printing IEEE Trans. Elec. Devices, ED-19 (4) 584 (1972).

17. L. Kuhn and A. Myers, Ink-jet printing, Scientific American, 240 (4) 162-178 (1979).

18. W. Lloyd and H. Taub, Ink-jet printing, Out Put Hardcopy Devices, C. Durbeck and S. Sherr, Eds. Acedemic Press, pp. 311-370 (1988).

19. D. H. Choi and F. C. Lee, Principles of electrohydrodynamic ink-jet printing, in Proc. IS&T's 7th Int'l. Congress on Adv. in Non-Impact Printing Technologies, IS&T, Springfield, Va., 1991, pp. 49-58.

20. R. N. Mills, ESIJET printing technology, in Proc. IS&T's NIP 12: In'l. Congress on Digital Printing Technologies, IS&T, Springfield, Va., 1996, pp. 262-266.

21. M. Miura and H. Naito, Ink-jet printing head utilizing air flow and electrostatic field, in Proc. 1st Int'l. Congress on Adv. in Non-Impact Printing Technologies, SPSE, Washington, D.C., 1984, pp. 154-156.

22. R. Uematsu, et al. (NEC), Electrostatis ink-jet recording head, European Patent Application EP 0764529 (1997).

23. S. A. Elrod, B. T. Khuri-Yakub and C. F. Quake, (Xerox), Stabilization of the free surface of a liquid, U.S. Pat. No. 5,629,724 (1997).

24. B. Hadimiodlu, et al. (Xerox), EP Application 0 572 220 (1993).

25. T. E. Johnson and K. W. Bower, Review of the drop on-demand ink-jet with primary emphasis on the gould jet concept, J. Appl. Photo. Eng. 5 (3), 174 (1979).

26. K. H. Fischbeck, (Spectra), U.S. Pat. No. 4,584,590 (1986).

27. W. S. (Xaar) Bartky, Droplet deposition apparatus, U.S. Pat. No. 4,879, 568 (1989).

28. A. J. Michaelis, (Xaar), Droplet deposition apparatus, U.S. Pat. No. 4,887,100 (1989).

29. W. Rung, in Proc. IS&T's 8th Int'l. Congress on Adv. in Non-Impact Printing Technologies, IS&T, Springfield, Va., 1992, p. 229.

30. T. Kitahata, Ink-jet head with multi-layer piezoelectric actuator, in Proc. IS&T's 11th Int'l. Congress on Adv. in Non-Impact Printing Technologies, IS&T, Springfield, Va., 1995, pp. 346-349.

31. G. Beurer, Function and performance of a shear mode piezo printhead, in Proc. IS&T's NIP 13: Int'l. Congress on Digital Printing Technologies, IS&T, Springfield, Va., 1997, pp. 6231-625.

32. D. Reichel, Computer to folex media for digital printing and imaging, in Proc. of IS&T's NIP13: In'l. Congress on Digital Printing Technologies, IS&T, Springfield, Va., 1997, pp. 410-412.

33. R. L. Adams, Phase-change ink-jet technology, in Proc. 9th Intl. Congress on Adv. in Non-Impact Printing Technologies/Japan Hardcopy '93, IS&T, Springfield, Va., 1993, pp. 290-293.

34. R. L. Adams, Printing technology of the Tektronix Phase 340, in Proc. 11th Int'l. Congress on Adv. in Non-Impact Printing Technologies, IS&T, Springfield, Va., 1995, pp. 280-283.

35. L. Bui, H. Fame, D. Titterington and W. Jaeger, Rheological, thermo-mechanical and viscoelastic requirements of a phase-change ink for an offset ink-jet printing process, in Proc. IS&T's 11th Int'l. Congress on Adv. in Non-Impact Printing Technologies, IS&T, Springfield, Va., 1995, pp. 338-341.

36. L. T. Creagh-Dexter, Applications in commercial printing for hot melt ink-jets, in Proc. IS&T's 10th Int'l. Congress on Adv. in Non-Impact Printing Technologies, IS&T, Springfield, Va., 1994, pp. 446-448.

37. J. D. Schofield, Ink systems for xaar ink-jet printhead, in Proc. IS&T's NIP 13: Int'l. Congress on Digital Printing Technologies, IS&T, Springfield, Va., 1997, pp. 633-637.

38. N. Ando and M. Takeuchi, Polymer grafted carbon black with high dispersibility and stability for ink-jet printers, in Proc. IS&T's NIP 13: Int'l. Congress on Digital Printing Technologies, IS&T, Springfield, Va., 1997, pp. 655-658.

39. D. E. Bugner and A. D. Bermel, Particle size effects in pigmented ink-jet inks, in Proc. IS&T's NIP 13: Int'l. Congress Digital Printing Technologies, IS&T, Springfield, Va., 1997, pp. 667-669.

40. J. E. Johnson and G. L. Bok, Surface-modified black pigments for industrial ink-jet applications, in Proc. IS&T's NIP 13: Int'l. Congress on Digital Printing Technologies, IS&T, Springfield, Va., 1997, pp. 659-663.

41. M. Shimomura, Ink for two-part liquid system recording, and ink set, ink container, recording unit, recording process and recording apparatus the same, European Patent Application 0776950 (1997).

1-46. (canceled)

47. A method of forming an electroluminescent device which comprises depositing an electroluminescent material on a substrate by ink jet printing to form an electroluminescent layer in which the electroluminescent material is selected from compounds of formula 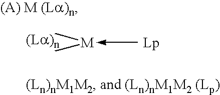
where Lα is selected from organic ligands and from compounds of formula: 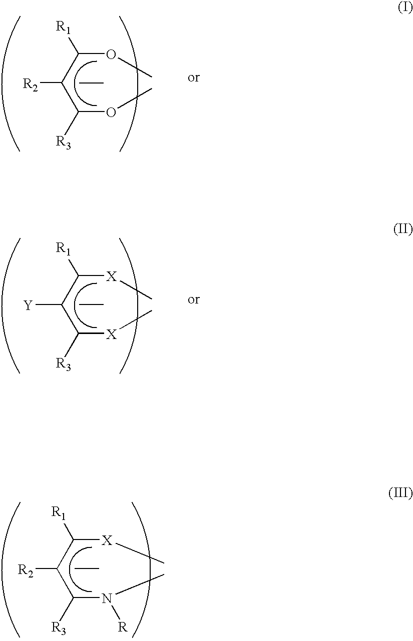
where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer X is Se, S or O, Y can hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorinie or thiophenyl groups or nitrile and the ligands Lα are the same or different;
Lp is a neutral organic ligand, or is of formula 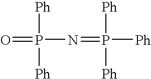
where each Ph which can be the same or different and can be a phenyl (OPNP) or a substituted phenyl group, other substituted or unsubstituted aromatic group, a substituted or unsubstituted heterocyclic or polycyclic group, a substituted or unsubstituted fused aromatic group such as a naphthyl, anthracene, phenanthrene or pyrene group;
M is a rare earth, transition metal, lanthanide or an actinide, M₂ is a non rare earth rare earth, transition metal, lanthanide or an actinide metal and
n is the combined valence state of M and M₁ and from compounds of formula 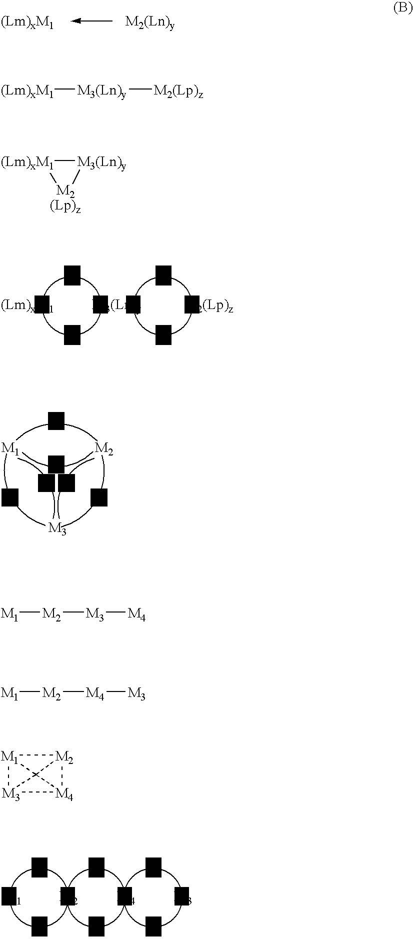
where L is a bridging ligand and where M₁ and M₃ are selected from a rare earth, transition metal, lanthanide or an actinide, M₂ is a non rare earth metals and M₄ is M₁;
Lm, Lp and Ln are the same or different organic ligands or is Lα, as defined above, x is the valence state of M₁, y is the valence state of M₂, and z is the valence state of M₃ and in which the rare earth metals and the non rare earth metals can be joined together by a metal to metal bond and/or via an intermediate bridging atom, ligand or molecular group or in which there are more than three metals joined by metal to metal bonds and/or via intermediate ligands.

48. A method according to claim 47 in which the said rare earth, transition metal, lanthanide or an actinide is selected from Sm(III), Eu(II), Eu(III), Tb(III), Dy(III), Yb(III), Lu(III), Gd(III), Gd(III), U(III), Tm(III), Ce(III), Pr(III), Nd(III), Pm(III), Dy(III), Ho(III) and Er(III) and the non rare earth metal M₂ is selected from lithium, sodium, potassium, rubidium, caesium, beryllium, magnesium, calcium, strontium, barium, copper, silver, gold, zinc, cadmium, boron, aluminium, gallium, indium, germanium, tin, antimony, lead, and metals of the first, second and third groups of transition metals, manganese, iron, ruthenium, osmium, cobalt, nickel, palladium, platinum, cadmium, chromium, titanium, vanadium, zirconium, tantalum, molybdenum, rhodium, iridium, titanium, niobium, scandium, and yttrium.

49. A method according to claim 47 in which the electroluminescent material is a selected from metal quinolates and lithium quinolate.

50. A method according to claim 47 in which the electroluminescent material is selected from non rare earth metal organo metallic complexes, aluminium, magnesium, zinc or scandium organo complexes, β-diketone complexes, Al(DBM)₃, An(DBM)₂ and MG(DBM)₂, Sc(DBM)₃ where (DBM) is Tris-(1,3-diphenyl-1-3-propanedione).

51. A method according to claim 47 there is a layer of a hole transporting material between the substrate and the electroluminescent layer.

52. A method according to claim 49 in which the substrate comprises an electrically conducting material which forms a first electrode which functions as an anode and there is a layer of a hole transporting material between the first electrode and the electroluminescent layer.

53. A method according to claim 50 in which the substrate comprises an electrically conducting material which forms a first electrode which functions as an anode and there is a layer of a hole transporting material between the first electrode and the electroluminescent layer.

54. A method according to claim 53 in which the hole transporting material is selected from aromatic amine complexes; poly(vinylcarbazole), N,N′-diphenyl-N,N′-bis(3-methylphenyl)-1,1′-biphenyl-4,4′-diamine (TPD); polyaniline, substituted polyanilines, ppolythiophenes; substituted polythiophenes, polysilanes and substituted polysilanes; conjugated polymers; poly(arylenevinylene) and substituted derivatives thereof; poly(p-phenylenevinylene-PPV and copolymers; poly(2,5 dialkoxyphenylene vinylene); poly (2-methoxy-5-(2-methoxypentyloxy-1,4-phenylenevinylene), poly(2-methoxypentyloxy)-1,4-phenylenevinylene), poly(2-methoxy-5-(2-dodecyloxy-1,4-phenylenevinylene) and other poly(2,5 dialkoxyphenylenevinylenes) with at least one of the alkoxy groups being a long chain solubilising alkoxy group; copolymers of an aniline monomer of the general formula 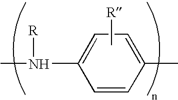
where R is in the ortho—or meta-position and is hydrogen, C1-18 alkyl, C1-6 alkoxy, amino, chloro, bromo, hydroxy or the group 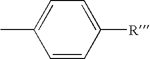
where R″ is alky or aryl and R″′ is hydrogen, C1-6 alkyl or aryl, with at least one other monomer of formula I above 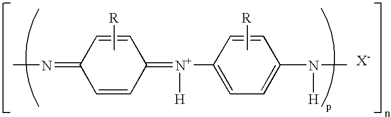
where p is from 1 to 10 and n is from 1 to 20, R is hydrogen, C1-18 alkyl, C1-6 alkoxy, amino, chloro, bromo, hydroxy p is 1 to 20 and n is 1 to 50 and X is an anion. polymers of formula 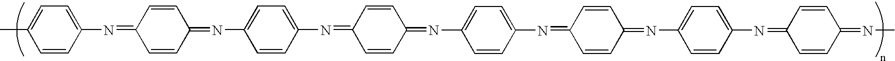
where X is selected from Cl, Br, SO₄, BF₄, PF₆, H₂PO₃, H₂PO₄, arylsulphonate, arenedicarboxylate, polystyrenesulphonate, polyacrylate alkysulphonate, vinylsulphonate, vinylbenzene sulphonate, cellusode sulphonate, cellulose sulphate or a perfluorinated polyanion; copolymers of aniline with o-anisidine, m-sulphanilic acid or o-aminophenol, or o-toluidine with o-aminophenol, o-ethylaniline or o-phenylene diaminie and substituted or unsubstituted polyaminonapthalenes, polyaminoanthracenes, polyamino phenanthrenes.

55. A method according to claim 47 in which there is a layer of an electron injecting material deposited on the electroluminescent layer.

56. A method according to claim 51 in which there is a layer of an electron injecting material deposited on the electroluminescent layer.

57. A method according to claim 53 in which there is a layer of an electron injecting material deposited on the electroluminescent layer.

58. A method according to claim 57 characterised the electron injecting material is selected from metal quinolates, a cyano-anthracene, 9,10 dicyano-anthracene, a polystyrene-sulphonate, aluminium quinolate and lithium quinolate.

59. A method according to claim 47 in which a second electrode selected from aluminium, calcium, lithium, or a silver/magnesium alloys is placed in contact with the electroluminescent layer and forms the cathode.

60. A method according to claim 57 in which a second electrode selected from aluminium, calcium, lithium, or a silver/magnesium alloys is placed in contact with the electron injecting layer and forms the cathode.

61. A method of forming an electroluminescent device which comprises depositing sequentially on a substrate (i) a first electrode; (ii) a layer of a hole transporting material; (iii) a layer comprising the electroluminescent material and (iv) a layer of an electron transporting layer material in which at least the layer of the electroluminescent material is deposited by ink jet printing and in which the electroluminescent layer is selected from compounds of formula 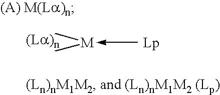
where Lα is selected from an organic ligand and compounds of formula 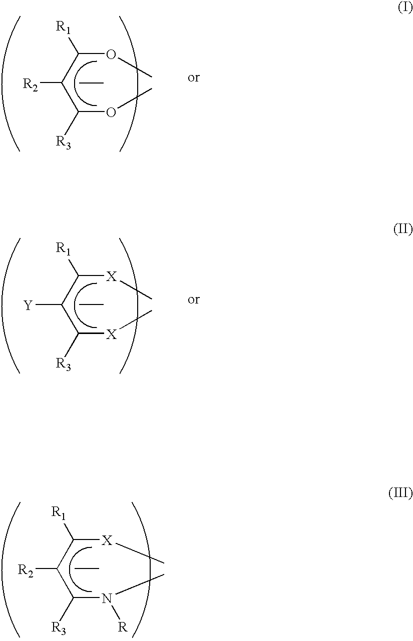
where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile and the ligands Lα are the same or different, Lp is a neutral organic ligand, or is of formula 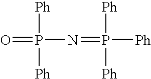
where each Ph which can be the same or different and can be a phenyl (OPNP) or a substituted phenyl group, other substituted or unsubstituted aromatic group, a substituted or unsubstituted heterocyclic or polycyclic group, a substituted or unsubstituted fused aromatic group such as a naphthyl, anthracene, phenanthrene or pyrene group;
M is selected from a rare earth, transition metal, lanthanide or an actinide, M₂ is a non rare earth rare earth, transition metal, lanthanide or an actinide metal,
n is the combined valence state of M and M₁ and from compounds of formula 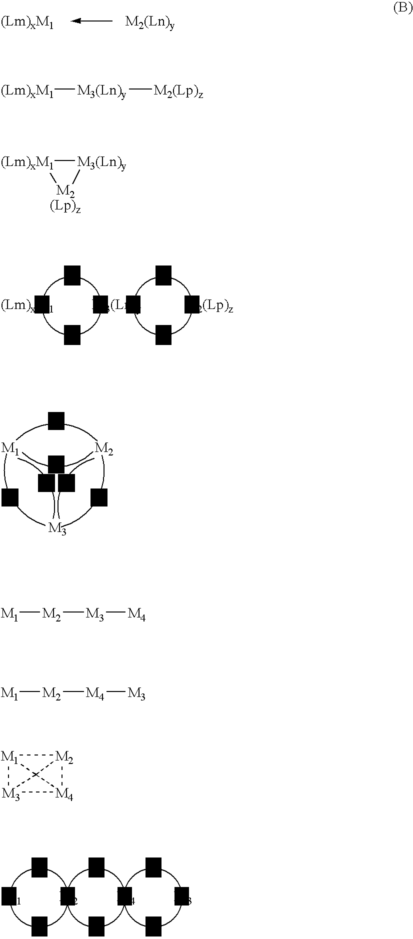
where L is a bridging ligand and where M₁ and M₃ are selected from a rare earth, transition metal, lanthanide or an actinide, M₂ is a non rare earth metals and M₄ is M₁;
Lm, Lp and Ln are the same or different organic ligands or is Lα, as defined above, x is the valence state of M₁, y is the valence state of M₂, and z is the valence state of M₃ and in which the rare earth metals and the non rare earth metals can be joined together by a metal to metal bond and/or via an intermediate bridging atom, ligand or molecular group or in which there are more than three metals joined by metal to metal bonds and/or via intermediate ligands.

62. A method according to claim 61 in which the said rare earth, transition metal, lanthanide or an actinide is selected from Sm(III), Eu(II), Eu(III), Tb(III), Dy(III), Yb(III), Lu(III), Gd (III), Gd(III), U(III), Tm(III), Ce (III), Pr(III), Nd(III), Pm(III), Dy(III), Ho(III) and Er(III) and the non rare earth metal M₂ is selected from lithium, sodium, potassium, rubidium, caesium, beryllium, magnesium, calcium, strontium, barium, copper, silver, gold, zinc, cadmium, boron, aluminium, gallium, indium, germanium, tin, antimony, lead, and metals of the first, second and third groups of transition metals, manganese, iron, ruthenium, osmium, cobalt, nickel, palladium, platinum, cadmium, chromium, titanium, vanadium, zirconium, tantalum, molybdenum, rhodium, iridium, titanium, niobium, scandium, and yttrium.

63. A method according to claim 61 in which the electroluminescent material is a selected from metal quinolates and lithium quinolate.

64. A method according to claim 61 in which the electroluminescent material is selected from non rare earth metal organo metallic complexes, aluminium, magnesium, zinc or scandium organo complexes, β-diketone complexes, Al(DBM)₃, Zn(DBM)₂ and Mg(DBM)₂, Sc(DBM)₃ where (DBM) is Tris-(1,3-diphenyl-1-3-propanedione).

65. A method according to claim 61 in which the hole transporting material and/or the electron transporting material and/or the light emitting metal compound are mixed to form one layer.
